(19) United States
(12) Patent Application Publication
(10) Pub. No.: US 2002/0128817 A1
(43) Pub. Date: Sep. 12, 2002

(54) Communication method for machine tools, production equipment, and robots

(76) Inventor: Gerhard Keller, Furth (DE)

Correspondence Address: Siemens Corporation, Intellectual Property Department, 186 Wood Avenue South, Iselin, NJ, 08830, US

(21) Appl. No.: 10/008,126

(22) Filed: Dec. 5, 2001

(30) Foreign Application Priority Data
Mar. 8, 2001 (DE) 10142343.8

(51) Int. Cl. G06F 17/20

(52) U.S. Cl. 704/8

(57) ABSTRACT

A communication device for machine tools, production equipment, and robots (M) to provide information for at least one user (A1, A2). Information (I1, I2) or an information request is transmitted in a selectable national language to a translation system (U1 to U3) and translated for another user (A1, A2), so that the information (I1, I2) is presented in a comprehensible manner.

### BACKGROUND OF THE INVENTION

1. Field of the Invention

The invention relates to a communication method for machine tools, production equipment, and robots to provide information for at least one user.

2. Related Information

Manufacturers of industrial systems, i.e., machine tools, production equipment, and robots, for example, generally offer service to their customers in order to maintain the systems after installation and startup. Customers commonly avail themselves of this service when problems occur with the systems.

Typically, manufacturers offer such maintenance services by telephone (through a service hotline, i.e.). More recently, manufacturers have started to offer such services through the Internet, such as by web-site or e-mail, among others.

This is all well and good until the service personnel and customers speak different national languages. With the ever-increasing connectivity of the world, this is becoming a more frequent occurrence. As a result, misunderstandings often occur when communication is carried out, particularly when only one of the native languages is being spoken. This can have serious consequences if operator errors occur on the respective machines as a result. Such consequences may be alright in other industries, but they are not acceptable in the industrial systems market where an error could result in a catastrophic event, such as a manufacturing plant shutting down.

In addition, communication problems during the service consultation further aggravate the problem by prolonging the call time. This not only irritates the customer, but also has real-world detrimental effects, such as extending the machine downtime.

The protracted service calls also may, in some cases, result in higher service charges.

The general aim of the invention is to improve the communication capability of a user of industrial systems. While these include, for example, machine tools, production equipment, and robots, the vast array of industrial systems are certainly within the province of the present invention. More specifically, the present invention aims to eliminate altogether the problem of service miscommunication resulting from a difference between the native tongues of the customer and service provider.

### OBJECTS AND SUMMARY OF THE INVENTION

According to the invention, the aforementioned aim is achieved generally by transmitting information or an information request from a user in a selectable national language to a machine communication system. The information or information request then is transferred to a translation system. Thereafter, the information or information request is transferred from the translation system to another user in a language understood by the latter, and the information or information request is transmitted to an output device that is accessible to the other user. Thus, a user can transmit information in his/her own native language in a comprehensible way to another user who speaks another language.

An advantageous method of the invention is characterized in that the translation system and/or the information transfer are used bi-directionally. Thus, users with different national languages can communicate in a comprehensible way with each other in their own languages.

A further advantageous method of the invention is characterized in that a destination address for the information or information request can be selected. Thus, based on his information or based on his information request, a user of industrial systems (i.e., machine tools, production equipment, robots, etc.) is able to designate to whom or to which address a message should be routed.

A further advantageous method of the invention is characterized in that the information is encrypted. Thus, only the sender and the recipient, who have the respective keys for decryption, can decrypt the information or information request.

A further advantageous method of the invention is characterized in that data links are utilized for information transfer that use Internet transfer protocols. Thus, the Internet can advantageously be used for data transfer.

A further advantageous method of the invention is characterized in that a translation system is used via Internet transfer protocols on a web server. Thus, a central translation system that is connected to the Internet can be advantageously used by a large number of users.

A further advantageous method of the invention is characterized in that a user receives a back translation of the information or information request. Thus, for example, before or after sending information or an information request to the addressee, a user can determine whether or not the translation system has used the proper terms for the translation.

A further advantageous method of the invention is characterized in that at least two translation systems, with different hardware and/or software, are used for the translation and/or back translation. Thus, with the help of at least two different translation systems, it can be determined whether and by which translation system correct or incorrect translation terms have been issued.

A further advantageous embodiment of the invention is characterized in that the translation system is integrated by hardware or software into at least one machine tool or production equipment or robot. Thus, the communication system can advantageously utilize existing resources such as, for example, a common power supply or a common data link. A further advantage is that the installation costs can be reduced by integration.

A further advantageous embodiment of the invention is characterized in that at any given time, a translation system can be used by several machine tools, production equipment, or robots. Thus, only one translation system is required; costs can advantageously be reduced.

A further advantageous embodiment of the invention is characterized in that data available to the users can be loaded into the communication system. Thus, integration of additional informational materials into the communication is advantageously possible.

### BRIEF DESCRIPTION OF THE DRAWINGS

FIG. 1. illustrates the present invention.

### DETAILED DESCRIPTION OF THE PREFERRED EMBODIMENTS

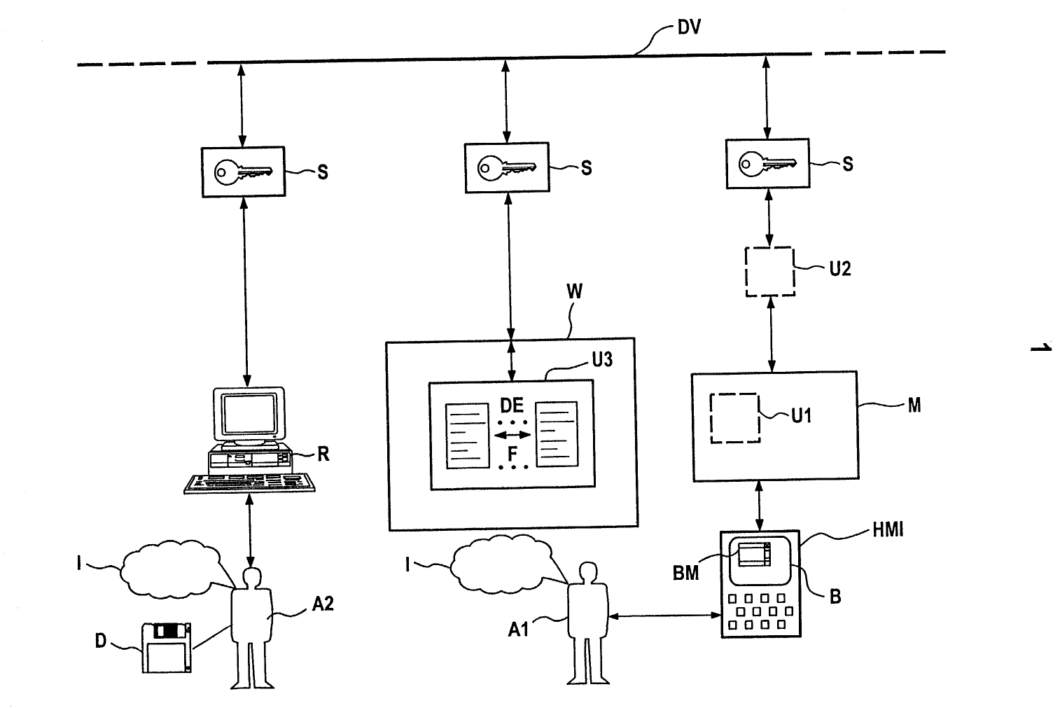

FIG. 1. illustrates a symbolic information routing for comprehensible communication of users with different national languages.

The present invention may be hosted by a human/machine interface (HMI) that is used to control an industrial control system. Industrial controllers are special purpose computers used for controlling industrial processes or manufacturing equipment. Under the direction of a stored program, the industrial controller examines a series of inputs reflecting the status of the control process and changes outputs affecting the control of the process. The inputs and outputs are most simply binary, that is “on” or “off”, however, analog inputs and outputs taking on a continuous range of values are also used. The binary inputs and outputs may be represented by single bits of data. The analog inputs and outputs may be represented by multiple bit data words.

In one common architecture for industrial controllers, a central processor executes a control program during which it reads and writes input and output values (I/O) from and to an I/O image table. The I/O image table is a local memory that collects the values of all inputs and outputs of the control system and which can be rapidly accessed without the complex communication protocols needed to exchange data directly with remote I/O modules. Thus, the I/O image table simplifies and speeds the execution of the control program.

Normally, separate circuitry, operating asynchronously to the processor, refreshes the VO image table by communicating with one or more I/O modules in a scanning process. The I/O modules are distributed about a factory to be near the machinery with which they communicate and communicate with the central processor via a high speed network as is known in the art.

The data that characterizes the control process may be displayed at a central location, for example, in a terminal connected to the central processor allowing an operator to monitor the operation of the process. At times, it may be also desirable to have such control data or portions of the control data displayed at various locations throughout the factory. Further it may be desirable to allow operators to input data to the control process from these different locations.

Accordingly it is known to incorporate into the control system a number of remote human/machine interfaces (HMI) to provide for such input and output at various locations about the factory. An HMI may be a simple display providing an indication of the status of the control process, or may be an industrially hardened computer terminal allowing for both the display of more complex types of control data and for the input by the operator of data. Such HMIs include internal programs or received data from a program running on the central processor to provide a local picture of the control process related to the machines near which they are located. Historical data representing the operation of the machine may also be displayed on the HMI.

An illustrative example of the invention is depicted in the drawing and is explained in more detail in the following. In the representation according to FIG. 1, information I1 is transmitted by a user A1 in his national language to a machine communication system HMI, A. By national languages, here we mean all languages used for human communication. However, it is also conceivable that self-defined languages, abridged languages, or even programming languages may be part of the communication, and if necessary can be translated.

User A1 can input his information I1 or his information request using display B of the machine communication system HMI, A. On the latter, for convenient input there can be screen masks within which he enters his information I1, I2. For example, standard mail programs can be used for this purpose. Direct integration into automation software is also possible. Data and communication routing are represented in the embodiment by double arrows, symbolizing that data flow can be bi-directional.

The information I1 input by user A1 is transmitted to a machine tool, production equipment, or robot M, where the translation system U1 is located. This is represented by a square with dashed line borders in the symbolic representation of machine M.

An additional option for positioning translation system U1 is shown in the embodiment by translation system U2. Translation system U2, which can be used for translation of information I1, I2 from all machines M, is located after one or more machines M.

If encryption S is selected by user A1, A2, then after translation the information is encoded. This means that only legitimate users A1, A2, and Thus, users A1, A2 with decoding keys, can access information I1, I2. Encryption or decryption S is drawn in the diagram symbolically by a function block with a key symbol.

The information I1, I2 is transmitted to an output device A over data links DV. The data link DV is represented by a horizontal line that is extended as a dashed line on both sides. This is supposed to indicate that more participants or systems can be on the data link DV. An Internet connection can be used as the data link DV, for example.

If user A2 has a decoding key, then he can decrypt information I1, I2 from user A1. This then is displayed on output device A in a language understood by user A2.

User A2 can now input the information I1, I2, which can also consist of stored data D, into output device A and transmit it to a translation system U1 to U3. The latter translates the information into information I1, I2 that can be understood by user A1. This can again be displayed on the machine communication system HMI, A.

With a translation system U1 to U3, the users A1, A2 who speak different national languages can communicate with each other in a comprehensible way. They can communicate with essentially few misunderstandings arising from language differences.

Users A1, A2 can select, on their machine communication systems HMI, A, which participants they would like to speak with via the data link DV. For example, it may be reasonable that a user A1, A2 would like to speak with a service representative if machine M breaks down. For example, based on information provided by the manufacturer of machine M, he can now select a service center of the machine manufacturer. It is additionally conceivable that a user A1, A2 would like to order accessories for a machine M so, for example, he contacts the sales department of the machine manufacturer.

It is additionally conceivable that a machine manufacturer M [sic] or a translation service provider offers a translation system U1 to U3 on a central web server W. In the embodiment, the web server W is represented by a rectangle in which the translation system U3 is located. The latter is again represented by a rectangle in which two documents are drawn symbolically with a double arrow between them. Above the double arrow, an identifying code for the national language DE [German] with dots underneath it symbolizes a source language, and under the double arrow a target language F with dots underneath it symbolizes a target language for the translation. The dots are supposed to indicate that it is possible to choose from a list of source and target languages. The documents are converted according to the language selection and then sent to the selected destination address.

It is possible for senders A1, A2 to select the source and target languages and Thus, to stipulate translation. However, it is also conceivable for a translation system U1 to U3 to recognize this automatically, for example, based on the country of origin of the information.

It is additionally possible that a translation system U1 to U3 can download one or more languages from a web server W. Thus, only the currently needed language is kept in the language memory of translation systems U1 to U3.

If user A1, A2 wants a back translation of his information I1, I2, then he can check how the translation has been performed. This can be used to make the translated information I1, I2 more precise. This can be extremely advantageous for avoiding errors, especially for critical transactions with a machine M. For the back translation, for example, different translation systems U1 to U3 can be used. The latter can involve different databases, methods, or different hardware. As a result, systematic translation errors can be neatly checked for and located.

1. Communication method for industrial systems to provide information for at least one user, comprising the steps of:
transmitting information or an information request by a user in a selectable national language to a machine communication system;
transferring the information or information request to a translation system;
transferring the information or information request from the translation system to another user in a language understood by the latter; and
the information or information request is transmitted to an output device that is accessible to the other user.

2. Communication method according to claim 1, further comprising the step of bidirectionally transferring the translation system and/or the information.

3. Communication method according to claim 1, further comprising the step of selecting a destination address of the information or information request.

4. Communication method according to claim 1, further comprising the step of encrypting the information.

5. Communication method according to claim 1, further comprising the step of utilizing data links that use Internet transfer protocols for information transfer.

6. Communication method according to claim 1, further comprising the step of using a translation system via Internet transfer protocols on a web server.

7. Communication method according to claim 1, further comprising the step of receiving a back translation of the information or information request.

8. Communication method according to claim 7, further comprising the step of utilizing at least two translation systems, with different hardware and/or software, for the translation and/or back translation.

9. Communication system for industrial systems to provide information for at least one user, comprising:
an information request in a selectable national language to be sent to a machine communication system;
a translation system for receiving the information request and for translating the information request;
an application for translating the information or information request to another user in a language understood by the latter; and
a translated information or information request sent to an output device that is accessible to the other user.

10. Communication system according to claim 9, wherein the information is bidirectionally transmitted.

11. Communication system according to claim 9, wherein the translation system is integrated by hardware or software into at least one of the following machine tool or production equipment or robot.

12. Communication system according to claim 9, wherein, at any given time, a translation system is used by several machine tools, production equipment, or robots.

13. Communication system according to claim 9, wherein data that is available to the users can be loaded into the communication system.
